(19) United States
(12) Patent Application Publication
(10) Pub. No.: US 2012/0093574 A1
(43) Pub. Date: Apr. 19, 2012

(54) UPPER BALL JOINT ASSEMBLY

(76) Inventor: Sage Carli, Orange, CA (US)

(21) Appl. No.: 12/905,121

(22) Filed: Oct. 15, 2010

(51) Int. Cl. F16C 11/06; B23P 17/00

(52) U.S. Cl. 403/122; 29/898.043; 29/898.1

(57) ABSTRACT

Embodiments of the invention are directed to an upper ball joint assembly for connecting an upper axle housing to a steering knuckle of a vehicle. In one embodiment, the upper ball joint assembly comprises a plurality of components including a tapered ball joint pin (or stud), a ball joint cup and a threaded cap configured to assemble together into an upper ball joint assembly. In an assembled configuration, a proximal, or head component, of the ball joint pin may be housed within one or more chambers (or tiers) of the ball joint cup. The cap may reversibly engage with the ball joint cup to complete the assembly. The ball joint assembly may have a hardness characteristic of between forty (40) and one-hundred (100) Rockwell.

### FIELD OF INVENTION

Automobile parts.

### BACKGROUND OF INVENTION

In an automobile, the steering assemblage allows the driver to control the vehicle. Typically, the steering wheel is connected to the suspension and wheels via the steering knuckles. The steering knuckles, in turn, connect the steering wheel to the rest of the automobile which allows the driver to direct the vehicle. Two control arms link the chassis and the front suspension, while leaf springs connect the chassis to the rear suspension. Tie rod ends connect to the steering knuckles, which directly control the wheels.

The control arms are connected to the frame with pivoting mounts. Ball joints connect the front axle to the steering knuckle. Ball joints allow the steering knuckle to pivot during steering. As the driver turns the wheel, motion is transferred down the steering shaft to the steering gear.

Factory-installed ball joints in automobiles typically require lubricant and generally need to be replaced every two (2) years with “normal” vehicle use. Over time, ball joint replacement is often required due to poor lubrication (infrequent or insufficient) or excessive play from the soft bronze bushing contained in the assembly. Additionally, severe impacts may cause increased compressive stress on conventional ball joints thereby compromising their integrity. As a result, under extreme uses, such as off-road driving and driving at higher speeds, a ball joint pin may become loose inside the cup creating excessive play in the steering.

After-market ball joints featuring ball joint cups with a “single tier” design are available to replace factory-installed ball joints. It has been found that such ball joints are not able to withstand to the pressure created by larger tires and/or off-road vehicle use. The “single tier” design may be constructed of a small cup chamber in which the pin is surrounded by a soft bronze bushing inside the cup, which often compresses or deforms creating excessive play.

### SUMMARY OF INVENTION

An upper ball joint assembly, comprising: (a) a ball joint cup having a cup opening extending therethrough, the cup opening comprising a first chamber, a second chamber and a stud-receiving aperture; (b) a tapered ball joint pin having a proximal portion, a medial portion and a distal portion, the proximal component comprising a head component, the head component of the pin adapted to reversibly seat within the ball joint cup; and (c) a cap having a cap opening extending therethrough, the cap adapted to reversibly engage with the ball joint cup wherein the joint assembly has a hardness of at least 56 Rockwell is herein disclosed.

From a proximal end of the ball joint cup to a distal end of the ball joint cup, the second chamber may follow the first chamber, the stud-receiving aperture may follow the second chamber. A diameter of the first chamber may be greater than a diameter of the second chamber. A diameter of the stud-receiving aperture may be less than the diameter of the second chamber. The medial and distal portions of the pin may comprise a stud, the stud may comprise a tapered portion followed by an externally-threaded portion, the externally-threaded portion may terminate in a tip portion. In an assembled configuration, the head component of the pin may be capable of vertical movement between the first chamber and the second chamber. The cap may comprise: (i) a hex portion, (ii) a medial portion and (iii) an externally-threaded distal portion.

From a proximal end of the cap to a distal end of the cap, the cap may comprise a hex-connecting component followed by a hex component followed by a flange component followed by an externally-threaded component. The hex-connecting component may be a zerk fitting. The upper ball joint assembly may further comprise a non-liquid lubricant applied to at least one inner surface of the assembly. The non-liquid lubricant may be polytetrafluroethylene. The upper ball joint assembly may be comprised of high-strength steel. The upper ball joint assembly does not include a bushing.

A process for manufacturing an upper ball joint assembly, comprising: (a) forming a ball joint cup from high-strength steel, the ball joint cup having a cup opening extending therethrough, the cup opening comprising a first chamber, a second chamber and a stud-receiving aperture; (b) forming a tapered ball joint pin from high-strength steel, the pin having a proximal portion, a medial portion and a distal portion, the proximal component comprising a head component, the head component of the pin adapted to reversibly seat within the ball joint cup; and (c) forming a portion of a cap from high-strength steel, the cap having a cap opening extending therethrough, the cap adapted to reversibly engage with the ball joint cup wherein the joint assembly has a hardness of at least 56 Rockwell is herein disclosed.

The process may further comprise applying a non-liquid lubricant to the assembly. The process may further comprise applying a heat treatment to the assembly to achieve the hardness greater than 56 Rockwell. The process may further comprise: (d) inserting the tapered ball joint pin into the ball joint cup such that at least the head component is seated within the ball joint cup; and (e) coupling the cap to the ball joint cup.

### BRIEF DESCRIPTION OF DRAWINGS

FIG. 1 illustrates a cross-sectional view of a conventional upper ball joint assembly in an assembled configuration.

FIG. 2 illustrates an exploded view of an upper ball joint assembly in an unassembled configuration according to an embodiment of the invention.

FIG. 3 illustrates a perspective view of the upper ball joint assembly of FIG. 2 in an assembled configuration.

FIG. 4 illustrates a diagram of a ball joint cup of an upper ball joint assembly according to an embodiment of the invention.

FIG. 5 illustrates a diagram of a tapered ball joint pin of an upper ball joint assembly according to an embodiment of the invention.

FIG. 6 illustrates a diagram of a threaded cap of an upper ball joint assembly according to an embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to an upper ball joint assembly for connecting an upper axle housing to a steering knuckle of a vehicle. In one embodiment, the upper ball joint assembly comprises a plurality of components including a tapered ball joint pin (or stud), a ball joint cup and a threaded cap configured to assemble together into an upper ball joint assembly. In an assembled configuration, a proximal, or head component, of the ball joint pin may be housed within one or more chambers (or tiers) of the ball joint cup. The cap may reversibly engage with the ball joint cup to complete the assembly. The ball joint assembly may have a hardness characteristic of between forty (40) and one-hundred (100) Rockwell.

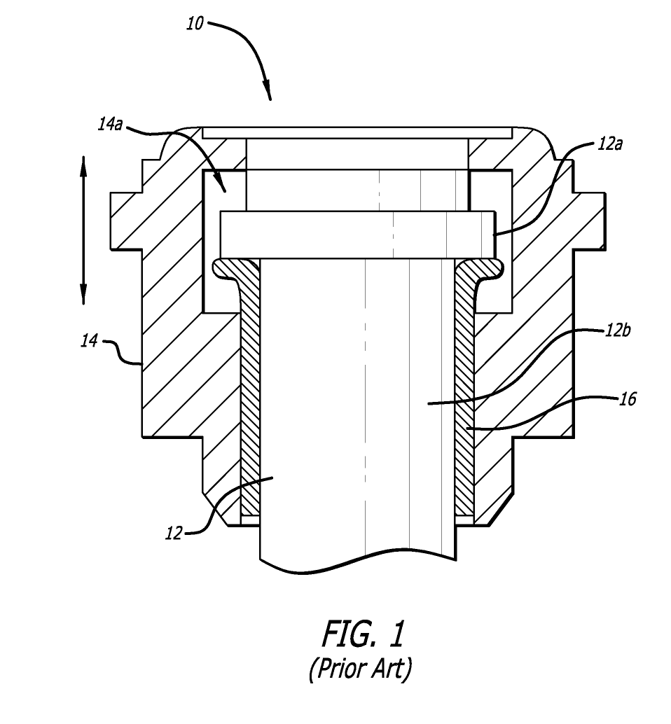

FIG. 1 illustrates a cross-sectional view of a conventional upper ball joint assembly 10 in an assembled configuration. As shown, the upper ball joint assembly 10 includes a ball joint pin 12 having a head component 12a and a stud component 12b, a ball joint cup 14 and a bushing 16 in which the stud component 12b of the ball joint pin 12 is housed. The head component 12a and an upper portion of the stud component 12b of the ball joint pin 12 generally reside within a chamber 14a of the ball joint cup 14. These components are limited in vertical movement by the height of the chamber 14a (see double arrow). Also, the bushing 16 is very soft and will deform easily when excessive pressure is applied to it when in use. Once the bushing 16 is deformed, excess play results (within the chamber 14a) and the ball joint assembly 10 must be replaced which translates into a premature lifetime of the assembly 10.

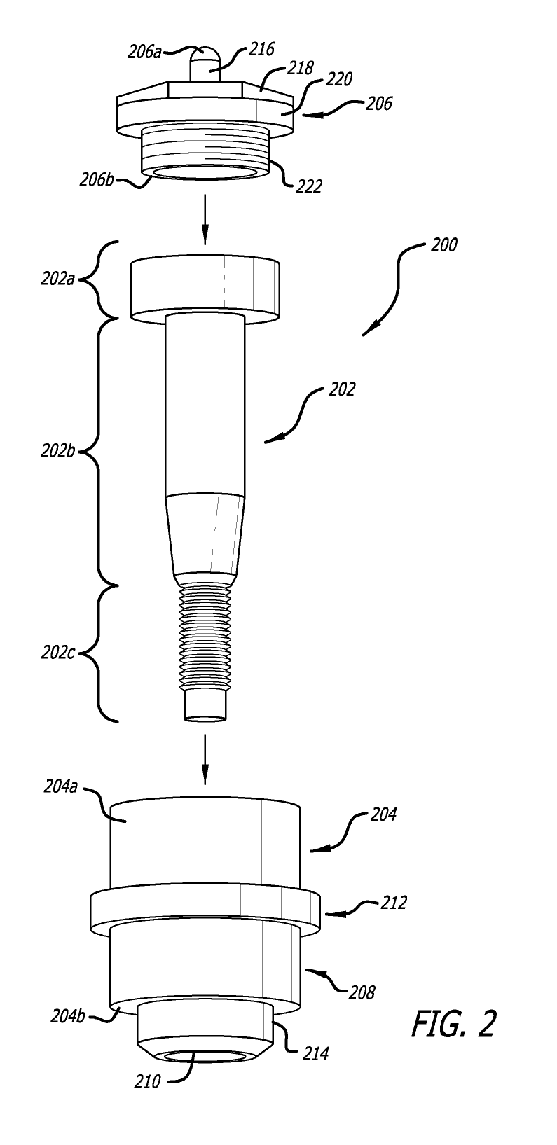

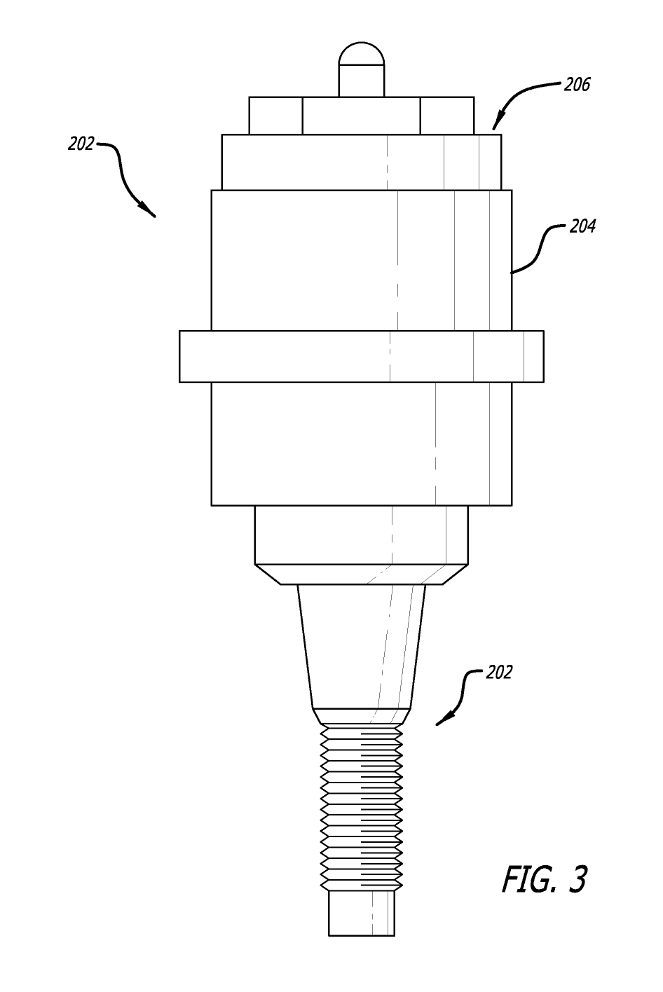

FIG. 2 illustrates an exploded view of an upper ball joint assembly 200 according to an embodiment of the invention. As shown, the upper ball joint assembly 200 includes a tapered ball joint pin 202, a ball joint cup 204 and a threaded cap 206 configured to assemble together as a single unit (see FIG. 3). In some embodiments, the tapered ball joint pin 202 includes a proximal portion 202a, a medial portion 202b, and a distal portion 202c. The proximal portion 202a may generally comprise a head component; the medial portion 202b may generally comprise a cylindrical component and terminate into a tapered component; and the distal portion 202c may generally comprise an externally-threaded distal component and terminate into a tip portion. Medial portion 202b and distal portion 202c may collectively be referred to as a “stud.” The head 202a of the tapered ball joint pin 202 is configured to seat within the ball joint cup 204 when the upper ball joint assembly 200 is in an assembled configuration (explained in more detail below).

Continuing to refer to FIG. 2, the ball joint cup 204 includes an approximately cylindrical housing 208 with a cup opening 210 extending therethrough (partially shown). In one embodiment, a flange 212 is situated about an outer circumference of the cylindrical housing 208. When installed in a vehicle, the flange 212 functions to increase contacting surface area to better distribute load and, moreover, prevents vertical motion of the assembled upper ball joint 200. From a proximal end 204a of the cup 204 to a distal end 204b of the cup 204, the flange 212 may be situated about midway therebetween, in one embodiment, between about 0.910 inches and 1.5 inches from the proximal end 204a; however, in any embodiment, the flange 212 should be situated such that it functions as previously described. In one embodiment, the cup 204 terminates into a connecting portion 214.

From a proximal end 206a to a distal end 206b of the threaded cap 206, cap 206 may include a hex-connecting component 216, followed by a hex component 218 followed by a flange component 220 followed by an externally-threaded component 222. The cap 206 is configured to reversibly couple to the cup 204 when the upper ball joint assembly 200 is in an assembled configuration, i.e., with the pin 202 seated within the cup 204 (explained in more detail below).

FIG. 3 illustrates a perspective view of the upper ball joint assembly of FIG. 2 in an assembled configuration. As shown, the threaded cap 206 is coupled to the ball joint 204 with a portion of the tapered ball joint pin 202 shown situated therein. The upper ball joint assembly 200 may be partially, substantially, or completely constructed from high strength alloys including carbon steels, chromium steel, molybdenum steels, vanadium steels, micro-alloyed steels, alloy steels including low- and high-alloy steels, stainless steel, super alloys, titanium alloys, aluminum alloys, copper alloys including copper-beryllium alloys, or various tool and die steels and other alloys. In one embodiment, the upper ball joint assembly 200 is constructed of 4340 (chromium-molybdenum (chromoly)) or 9310 (nickel-chromium-molybdenum) steel.

Examples of AISI designations for these alloys include, but are not limited to 10xx, 11xx, 12xx, 13xx, 15xx, 23xx, 25xx, 29xx, 31xx, 32xx, 33xx, 34xx, 40xx, 41xx, 43xx, 44xx, 46xx, 47xx, 48xx, 50xx, 51xx, 52xx, 61xx, 72xx, 81xx, 86xx, 87xx, 88xx, 92xx, 93xx, 94xx, 97xx, and 98xx and many modifications based on these alloys. As used herein “xx” designates specific composition, i.e. grade, of the alloy. Almost all alloys also have other designations in addition to AISI designation and sometime specific alloys have names. Although high-strength low-alloy steels are preferred materials for the upper ball joint according to embodiments of the invention other alloys or their alloy hybrids may be suitable. In one embodiment, the upper ball joint assembly 200 may also be carburized and/or heat treated to achieve hardness of between (40) and one-hundred (100) Rockwell Hardness in C-scale (HRC) and tensile strengths of over 300 kilo pound per square inch (kpsi).

The “Rockwell scale” is a hardness scale based on the indentation hardness of a material. A Rockwell test determines the hardness by measuring the depth of penetration of an indenter under specific loads from 60 kilograms force (kgf) to 150 kgf and specific indenter configurations corresponding to letters A through G. Rockwell hardness C corresponds to a load of 150 kgf and 120 degree diamond cone indenter. The numerical expression of hardness in a Rockwell scale represents the load in kilograms force. In one embodiment, the upper ball joint assembly 200 has a hardness of at least fifty-six (56) HRC, in one embodiment, sixty (60) HRC. The ultimate strength of a material is a function of its composition and the heat treatment process to which is it subjected.

Ultimate strength is a measure of the ability of the material to withstand an applied stress, usually in tension, before fracture. One pound force applied to one inch square results in one psi stress. One thousand pound force applied to one inch square produces one kpsi (also known as ksi), stress. In one embodiment, the ultimate strength of the upper ball joint 200 is about 175 ksi.

In some embodiments, the upper ball joint assembly 200 may also be heat treated to achieve a hardness of between forty (40) and one-hundred (100) Rockwell. The “Rockwell scale” is a hardness scale based on the indentation hardness of a material. A Rockwell test determines the hardness by measuring the depth of penetration of an indenter under a large load compared to the penetration made by a preload. The numerical expression of hardness in a Rockwell scale represents the load in kilogram force. In one embodiment, the upper ball joint assembly has a hardness of at least sixty (60) Rockwell.

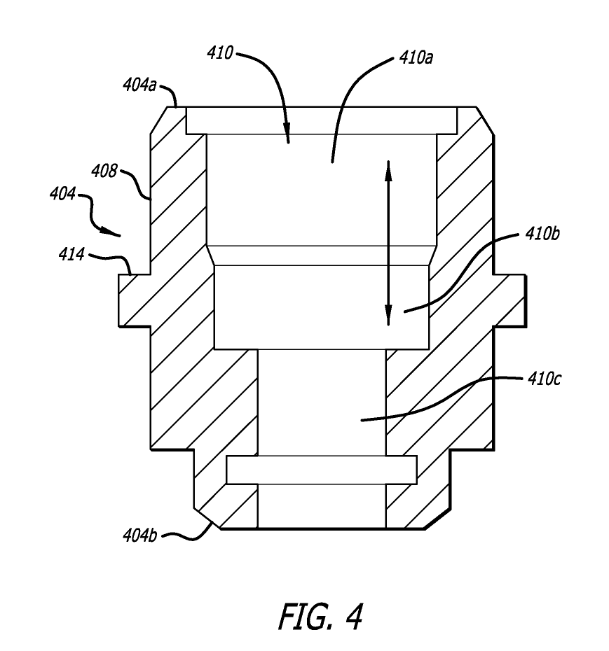

FIG. 4 illustrates a diagram of a ball joint cup of an upper ball joint assembly according to an embodiment of the invention. As shown, the ball joint cup 404 includes an approximately cylindrical housing 408 with a cup opening 410 extending therethrough and a flange 414. From a proximal end 404a of the ball joint cup 400 to a distal end 404b of the ball joint cup 404, the cup opening 410 may include a first chamber 410a (or, first tier), a second chamber 410b (or, second tier) and a stud-receiving aperture 410c. In some embodiments, a diameter of the first chamber 410a is greater than a diameter of the second chamber 410b. For example, the diameter of the first chamber 410a may be between about 0.95 inches and 2.75 inches while the diameter of the second chamber 410b may be between about 0.88 inches and 2.5 inches.

In an assembled configuration, a head component of a tapered ball joint pin (not shown) may be permitted to vertically move between first and second chambers 410a, 410b (see double arrow). The dual chamber (or, dual tier) design of the assembly 400 provides additional material and surface area in which the head component of the tapered ball joint pin (not shown) may be permitted to vertically move when the upper ball joint assembly is in use (i.e., when the assembly is installed between an upper axle housing to a steering knuckle of a vehicle and the vehicle is in use). Consequently, the upper ball joint assembly according to embodiments of the invention results in increased strength relative to conventional upper ball joint assemblies. These features also translate to an extended lifetime of the upper ball joint assemblies according to embodiments of the invention.

Continuing to refer to FIG. 4, the stud-receiving aperture 410c may be configured to receive a stud component of the tapered ball joint pin (not shown). In some embodiments, a diameter of the stud-receiving aperture 410c is less than the diameter of the second chamber 410b (and, therefore, also less than the diameter of the first chamber 410a). For example, the diameter of the stud-receiving aperture 410c may be between about 0.880 inches and 0.885 inches. The stud-receiving aperture 410c is narrow enough to receive the stud component of the tapered ball joint pin yet allows some play therein.

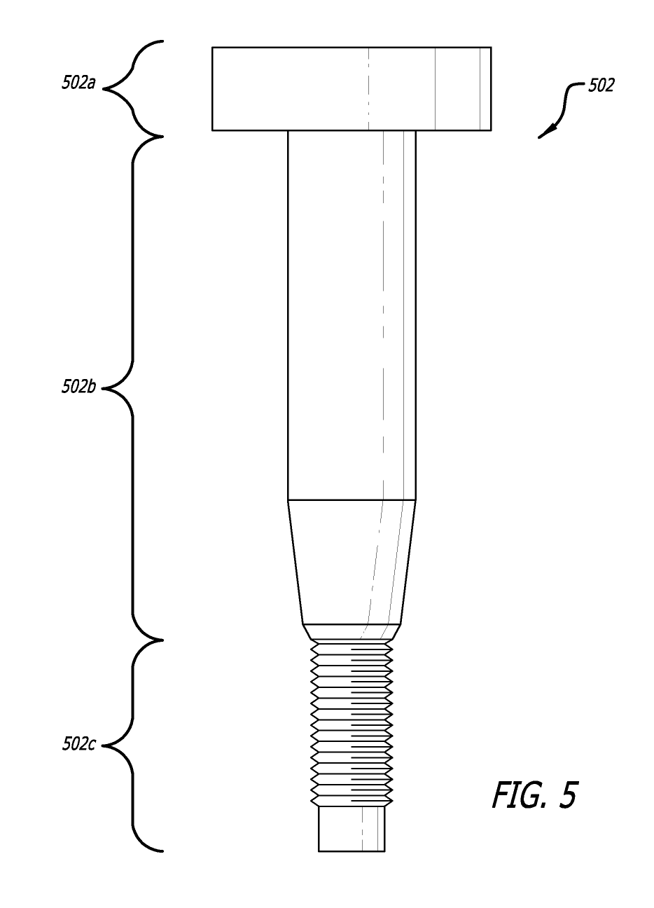

FIG. 5 illustrates a diagram of a tapered ball joint pin of an upper ball joint assembly according to an embodiment of the invention. As shown, the tapered ball joint pin 502 includes a proximal portion 502a, a medial portion 502b, and a distal portion 502c. The proximal portion 502a may be a head component with a diameter of between 0.85 inches and 2.4 inches plus or minus 0.0005 inches, and a height of between about 0.5 inches and 1.0 inches. The medial portion 502b may begin as a cylindrical component with a diameter of between 0.85 inches and 0.88 inches, in one embodiment, about 0.874 inches plus or minus 0.0005 inches, and terminate into a tapered component, with a total height of about 2.25 inches. The distal portion 502c may begin as an externally-threaded distal component and terminate into a tip portion with a total height of about 1.235 inches. In one embodiment, the tip portion is a 7/16 inch hex nut.

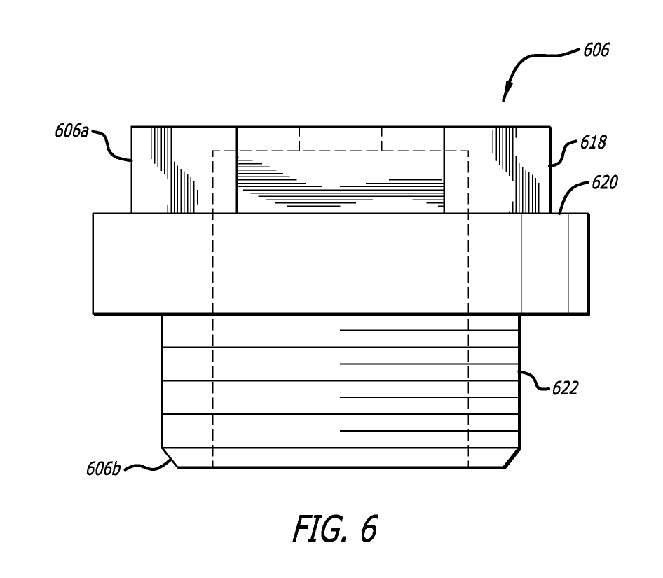

FIG. 6 illustrates a diagram of a threaded cap of an upper ball joint assembly according to an embodiment of the invention. From a proximal end 606a to a distal end 606b of the threaded cap 606, cap 606 may include a hex-connecting component (not shown; see FIG. 2), followed by a hex component 618 followed by a flange component 620 followed by an externally-threaded component 622.

It should be appreciated that the upper ball joint assembly according to embodiments of the invention do not include a bushing (i.e., the assembly is bushing-less). This is a significant advantage over conventional assemblies because the natural wear of assemblies having bushings (see FIG. 1) is a principle cause of the assembly having to be frequently replaced. Frequent replacement of such components is costly to the end-user over time.

According to embodiments of the invention, the upper ball joint assembly as previously described may be manufactured as follows. A high-strength steel may be machined to create one or more components of the upper ball joint assembly, i.e., a tapered ball joint pin (or stud), a ball joint cup and/or a threaded cap. Then, the assembled components may be heat treated to achieve a hardness of between forty (40) and one-hundred (100) Rockwell. Then, a non-liquid lubricant (i.e., a “dry-lube”) may be applied to the assembled components to a specified thickness of between 0.05 millimeters and 0.09 millimeters. The dry-lube may be applied in one or more applications or stages to one or more surfaces of the assembly. Examples of suitable dry-lubes include, but are not limited to, polytetrafluroethylene (PTFE), graphite, molybdenum disulfide and tungsten disulfide.

According to embodiments of the invention, the upper ball joint assembly as previously described was discovered to break-in after use and, therefore, increase performance. The manufacturing process as previously described was discovered to result in a substantially smooth inner surface of the assembly, which inner surface was discovered to contain a plurality of pores generally not visible by the eye. In one embodiment, the lubrication process partially, substantially or completely fills the pores of the surface of the assembly. After a period of time and consistent use (i.e., when the assembly is installed in vehicles as previously described), it was discovered that the surface(s) of the assembly burnished. Applicant discovered that, upon removing the pin from the assembly, the inner surfaces of the assembly exhibited a luster caused by burnishing through normal use of the assembly. The burnished surfaces were discovered by Applicant to result in reduced friction and smoothed-out rotation relative to non-burnished surfaces. This discovery was unexpected in view of the conventional expectation is that such assemblies decrease in performance after repeated use. Applicant discovered that the superior performance of the assemblies according to embodiments of the invention were partially or substantially due to the design and manufacture of the ball joint cup, i.e., the additional material and surface provided by the two-tiered ball joint cup; the heating process resulting in increased hardness (Rockwell); and the two-stage lubrication process.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. An upper ball joint assembly, comprising:
a ball joint cup having a cup opening extending therethrough, the cup opening comprising a first chamber, a second chamber and a stud-receiving aperture;
a tapered ball joint pin having a proximal portion, a medial portion and a distal portion, the proximal component comprising a head component, the head component of the pin adapted to reversibly seat within the ball joint cup; and
a cap having a cap opening extending therethrough, the cap adapted to reversibly engage with the ball joint cup wherein the joint assembly has a hardness of at least 56 Rockwell.

2. The upper ball joint assembly of claim 1 wherein, from a proximal end of the ball joint cup to a distal end of the ball joint cup, the second chamber follows the first chamber, the stud-receiving aperture follows the second chamber.

3. The upper ball joint assembly of claim 2 wherein a diameter of the first chamber is greater than a diameter of the second chamber.

4. The upper ball joint assembly of claim 3 wherein a diameter of the stud-receiving aperture is less than the diameter of the second chamber.

5. The upper ball joint assembly of claim 1 wherein the medial and distal portions of the pin comprise a stud, the stud comprising a tapered portion followed by an externally-threaded portion, the externally-threaded portion terminating in a tip portion.

6. The upper ball joint assembly of claim 5 wherein, in an assembled configuration, the head component of the pin is capable of vertical movement between the first chamber and the second chamber.

7. The upper ball joint assembly of claim 1 wherein the cap comprises (i) a hex portion, (ii) a medial portion and (iii) an externally-threaded distal portion.

8. The upper ball joint assembly of claim 7 wherein, from a proximal end of the cap to a distal end of the cap, the cap comprises a hex-connecting component followed by a hex component followed by a flange component followed by an externally-threaded component.

9. The upper ball joint assembly of claim 8 wherein the hex-connecting component is a zerk fitting.

10. The upper ball joint assembly of claim 1, further comprising, a non-liquid lubricant applied to at least one inner surface of the assembly.

11. The upper ball joint assembly of claim 10 wherein the non-liquid lubricant is polytetrafluroethylene.

12. The upper ball joint assembly of claim 1 wherein the upper ball joint assembly is comprised of high-strength steel.

13. The upper ball joint assembly of claim 1 wherein the assembly does not include a bushing.

14. A process for manufacturing an upper ball joint assembly, comprising:
forming a ball joint cup from high-strength steel, the ball joint cup having a cup opening extending therethrough, the cup opening comprising a first chamber, a second chamber and a stud-receiving aperture;
forming a tapered ball joint pin from high-strength steel, the pin having a proximal portion, a medial portion and a distal portion, the proximal component comprising a head component, the head component of the pin adapted to reversibly seat within the ball joint cup; and
forming a portion of a cap from high-strength steel, the cap having a cap opening extending therethrough, the cap adapted to reversibly engage with the ball joint cup wherein the joint assembly has a hardness of at least 56 Rockwell.

15. The process of claim 14, further comprising, applying a non-liquid lubricant to the assembly.

16. The process of claim 15, further comprising, applying a heat treatment to the assembly to achieve the hardness greater than 56 Rockwell.

17. The process of claim 15, further comprising:
inserting the tapered ball joint pin into the ball joint cup such that at least the head component is seated within the ball joint cup; and
coupling the cap to the ball joint cup.
